(19) United States
(12) Patent Application Publication
(10) Pub. No.: US 2026/0262870 A1
(43) Pub. Date: Sep. 10, 2026

(54) COLD BREW BOTTLE

(71) Applicants: PRAIRIE PLASTIC HARDWARE CO., LTD., Dongguan City, Guangdong (CN); FREE-FREE INDUSTRIAL CORP., Taipei City (TW)

(72) Inventors: Wei-Ni TU, Taipei City (TW); Chien-Hua LIAO, Taipei City (TW)

(21) Appl. No.: 18/997,804

(22) PCT Filed: Aug. 16, 2022
(86) PCT No.: PCT/CN2022/112768

§ 371 Date: Oct. 20, 2025

(51) Int. Cl. A47J 31/20

(52) U.S. Cl. CPC A47J 31/20

(57) ABSTRACT

A cold brew bottle includes a bottle body having a cavity, an opening communicating with the cavity, and a bottle rim formed at the opening of the bottle body, a hollow rubber ring sheathing the bottle rim and having an inner edge extended to form a hanging convex part for hanging a filter and containing the filter in the cavity, a connection ring sheathing the hollow rubber ring and screwed with the bottle body, and a bottle cap detachably combined with the connection ring to close the cavity, in which the bottle cap is not in contact with the hollow rubber ring, the filter may be taken out or placed directly into the cold brew bottle after the bottle cap is opened, and the waterproof sealing effect of the cold brew bottle may be improved.

### CROSS-REFERENCE TO RELATED APPLICATION

This application is the National Phase of PCT International Application No. PCT/CN 2022/112768 filed on Aug. 16, 2022. The entire disclosures of the above application are all incorporated herein by reference.

### BACKGROUND OF THE DISCLOSURE

### Technical Field

The present disclosure relates to a water bottle, particularly relates to a cold brew bottle for preparing beverages.

### Description of Related Art

Coffee, tea, and fruit juice are commonly consumed by the general public. With the promotion of the concept of health care and the food safety concerns of merchants in the market, many people have turned to make their own beverages at home or in the office, not only in terms of food safety and health is more at ease, but the price of homemade beverages is also much cheaper, so many manufacturers have developed a variety of beverage preparation appliances to provide consumers with a variety of choices. Among them, a common beverage preparation appliance is the filter-type cold brew bottle, which is used to put extractable substances such as tea leaves, coffee powder or fruit pulp into a filter and soak them in water to produce a beverage.

In general, the cold brew bottle includes a bottle body and a filter. Since it is necessary to set a spout and a handle on the bottle body, most bottle bodies come with a two-design to facilitate the manufacture, in which the spout and the handle can be molded in a connecting ring and then installed in the bottle body, and an O-ring is used to seal the gap between the two. Most filters are directly stuck on the bottle rim or the connection ring, so it is not easy to remove the filter to use the cold brew bottle as a water bottle, and it is not easy to remove the filter in order to clean or replace the filter. In addition, the connection ring and the bottle body are mostly screwed together and fixed, and the O-ring is clamped between the connection ring and the bottle body, thus causing the O-ring to be squeezed, deformed and deteriorated by stress, and affecting the sealing effect in a long term of use.

In view of the deficiencies of the related art, the present discloser conducted researches based on the existing technologies and the application of theories, and finally developed a cold brew bottle in accordance with the present disclosure to overcome the deficiencies of the related art.

### SUMMARY OF THE DISCLOSURE

The main purposes of the present disclosure are to allow a filter to be removed or placed directly into a cold brew bottle after a bottle cap of the cold brew bottle is opened, and to improve the waterproof sealing effect of the cold brew bottle.

To achieve the aforementioned purposes, the present disclosure provides a cold brew bottle, including a bottle body, a hollow rubber ring, a filter, a connection ring and a bottle cap. The bottle body has a cavity, an opening communicating with the cavity, and a bottom rim formed at the opening of the bottle body, the hollow rubber ring sheathes the bottle rim, and has a hanging convex part extended and formed at an inner edge of the hollow rubber ring, the filter is hung on the hanging convex part of the hollow rubber ring and contained in the cavity, the connection ring sheathes the hollow rubber ring and is screwed with the bottle body, the bottle cap is detachably combined with the connection ring and provided for closing the cavity, and the bottle cap is not in contact with the hollow rubber ring.

In an embodiment of the present disclosure, the top edge of the hollow rubber ring extends and bends outward to form a sleeve part, and the sleeve part sheathes the bottle rim.

In an embodiment of the present disclosure, the bottle rim is provided with at least one positioning notch, the hollow rubber ring is provided with at least one positioning bump, the positioning bump is engaged with the positioning notch to prevent the hollow rubber ring from rotating relative to the bottle body.

In an embodiment of the present disclosure, the filter includes a fixing cover and a filter basket, the filter basket is detachably installed at the fixing cover, and the filter basket is provided with a plurality of slots.

In an embodiment of the present disclosure, the fixing cover is in a substantially circular shape, the hanging convex part is substantially ring shaped, the outer edge of the fixing cover is formed with a step difference, and the step difference corresponds to the hanging of the hanging convex part.

In an embodiment of the present disclosure, the fixing cover is provided with a plurality of snap blocks, the filter basket is provided with a plurality of limiting element structures, and each snap block is engaged and positioned with each corresponding limiting element structure to vertically limit the fixing cover.

In an embodiment of the present disclosure, each limiting element structure includes a vertical groove and a horizontal groove perpendicular to each other, each horizontal groove is provided with a limiting bump, and each snap block is engaged with each corresponding limiting bump to transversally limit the fixing cover.

In an embodiment of the present disclosure, the connection ring is inwardly formed with a first combining part, the bottle cap is provided with a second combining part, and the second combining part is combined with the corresponding first combining part.

In an embodiment of the present disclosure, the first combining part is provided with at least one arc convex strip, the second combining part is provided with a spiral guide groove, and the arc convex strip is rotatably engaged with the corresponding spiral guide groove.

In an embodiment of the present disclosure, the second combining part is further provided with a stop block, and the stop block is located at an end of the spiral guide groove away from the filter and provided for stopping the arc convex strip.

In an embodiment of the present disclosure, the cold brew bottle further includes a rubber waterproof gasket, sheathing the second combining part and clamped between the bottle cap and the connection ring.

With the hanging convex part of the hollow rubber ring, the cold brew bottle of the present disclosure allows the filter to be removed or placed directly into the cold brew bottle after a bottle cap is opened, and the hollow rubber ring sheathes the bottle rim to improve the waterproof sealing effect of the cold brew bottle.

### BRIEF DESCRIPTION OF THE DRAWINGS

FIG. 1 is a perspective view of the present disclosure.

FIG. 2 is an exploded view of the present disclosure.

FIG. 3 is an exploded view showing a bottle body and a hollow rubber ring of the present disclosure.

FIG. 4 is an exploded view of a filter of the present disclosure filter.

FIG. 5 is a partially cross-sectional view of the filter of the present disclosure.

FIG. 6 is a partially cross-sectional view of the present disclosure.

FIG. 7 is another partially cross-sectional view of the present disclosure.

### DETAILED DESCRIPTION

The detailed description and technical contents of the present disclosure are illustrated with reference to the accompanying drawings, which are intended for the illustrative purposes only, but not intended for limiting the disclosure.

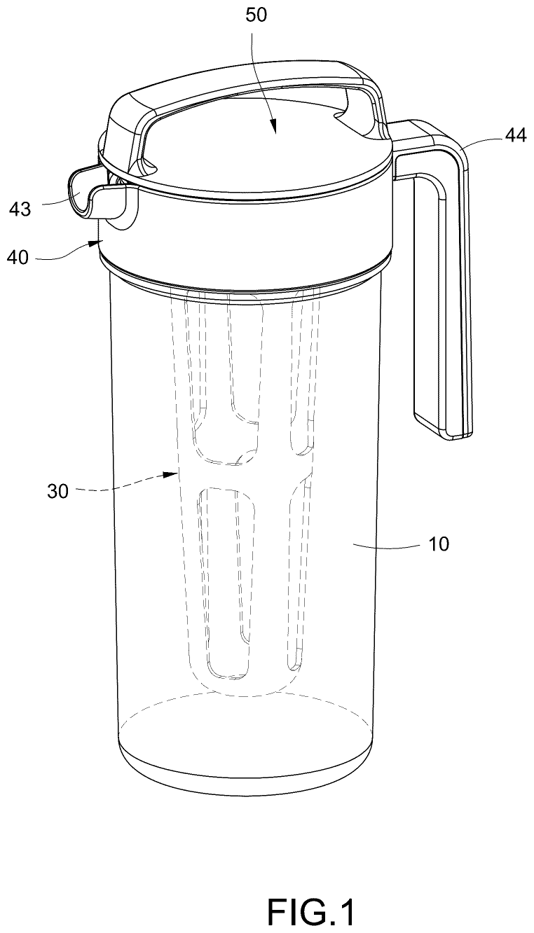

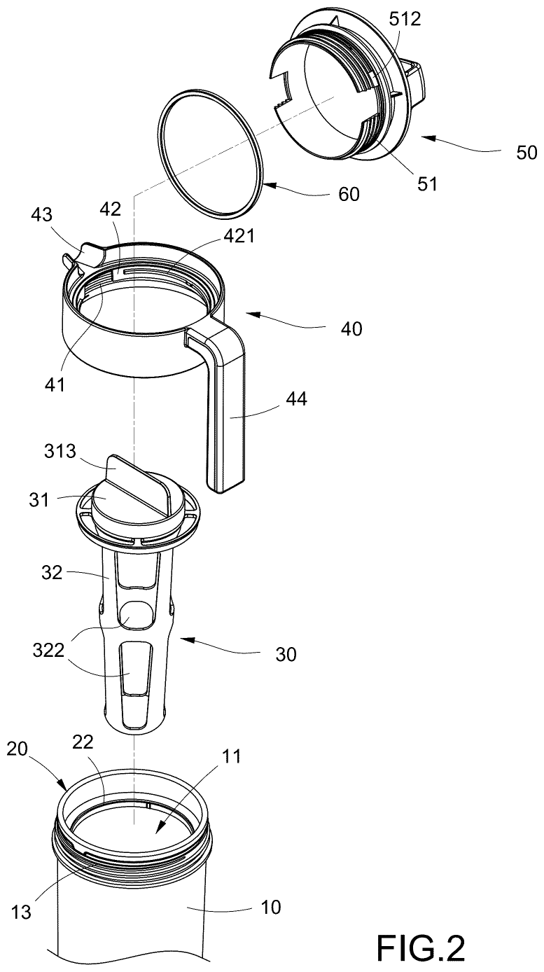

The present disclosure provides a cold brew bottle which is used to extract extractable substances such as tea leave, coffee powder or fruit pulp after filling fresh water into the bottle to brew a beverage. With reference to FIGS. 1 to 7 for the cold brew bottle of the present disclosure, the cold brew bottle mainly includes a bottle body 10, a hollow rubber ring 20, a filter 30, a connection ring 40 and a bottle cap 50.

The bottle body 10 is in a substantially hollow cylindrical shape, and has a cavity 11 and an opening (not shown in the figure) communicating with the cavity 11. The opening is provided for a user to pour liquid into the cavity 11 or pour liquid out from the cavity 11. The bottle body 10 at the opening is formed with a bottle rim 12, and the bottle rim 12 corresponds to the bottle body 10 and is in a substantially circular shape. In this embodiment, the bottle body 10 is made of ECOZEN™, but the present disclosure is not limited to this material. For example, the bottle body 10 may also be made of glass, stainless steel, aluminum alloy, titanium alloy, PP (polypropylene), AS (acrylonitrile-styrene copolymer) or Tritan™ (poly cyclohexylene dimethylene terephthalate, glycol modified) material.

The hollow rubber ring 20 is substantially ring shaped and sheathes the bottle rim 12. In some embodiments, the top edge of the hollow rubber ring 20 is bent and extended to form a hook-shaped sleeve part 21, such that the hook-shaped sleeve part 21 may sheathe the bottle rim 12 directly, and the outer diameter of the hollow rubber ring 20 has a tight fit to the inner diameter of the bottle body 10 to closely attach the hollow rubber ring 20 with the inner wall of the bottle body 10, so as to achieve a desirable waterproof sealing effect. In this embodiment, the hollow rubber ring 20 is made of silicone, and the soft deformable property of this material provides a desirable waterproof sealing effect, but the present disclosure is not limited to such material. The inner edge of the hollow rubber ring 20 extends towards the center to form a ring-shaped hanging convex part 22, and the hanging convex part 22 is provided for hanging the filter 30 and contained in the cavity 11 to facilitate the placement or removal of the filter 30.

The connection ring 40 is in a substantially hollow ring shape, which sheathes the hollow rubber ring 20 and is screwed with the bottle body 10. In some embodiments, the outer periphery of the bottle body 10 is provided with an external thread 13 which is formed at the bottom of the bottle rim 12, the bottom of the inner edge of the connection ring 40 is formed with an internal thread 41. The internal thread 41 of the connection ring 40 is screwed and fixed to the external thread 13 of the bottle body 10 to fix the connection ring 40 on the bottle body 10, and the sleeve part 21 of the hollow rubber ring 20 is clamped between the bottle rim 12 and the connection ring 40 to further enhance the waterproof sealing effect. It is noteworthy that the sleeve part 21 is not clamped and fixed directly, so that the sleeve part 21 is durable and may not be deformed or deteriorated easily. In this embodiment, the connection ring 40 is made of PP (polypropylene), but the present disclosure is not limited to this material. For example, the connection ring 40 can also be made of stainless steel, aluminum alloy, titanium alloy, AS (acrylonitrile-styrene copolymer), PC (Polycarbonate), ABS (Acrylonitrile Butadiene Styrene), HDPE (High-density polyethylene), or PS (Polystyrene), etc.

The bottle cap 50 is detachably combined with the corresponding connection ring 40 to close the cavity 11, and the bottle cap 50 is not in contact with the hollow rubber ring 20. In some embodiments, the inner wall of the connection ring 40 is formed with a first combining part 42 protruding towards the center, the bottle cap 50 is provided with a second combining part 51 which is combined with the corresponding first combining part 42. In this embodiment, the bottle cap 50 is made of PP (polypropylene), but the present disclosure is not limited to this material. For example, the bottle cap 50 can also be made of stainless steel, aluminum alloy, titanium alloy, AS (acrylonitrile-styrene copolymer), PC (Polycarbonate), ABS (Acrylonitrile Butadiene Styrene), HDPE (High-density polyethylene), or PS (Polystyrene), etc.

In this embodiment, the first combining part 42 is provided with at least one arc convex strip 421, the second combining part 51 is provided with a spiral guide groove 511, the arc convex strip 421 is operably screwed and engaged with the corresponding spiral guide groove 511, but the present disclosure is not limited to this arrangement. In some embodiments, the spiral guide groove 511 is formed by winding the spiral convex strip. In this embodiment, there are two arc convex strips 421 of the first combining part 42 and they are configured relative to each other, so each arc convex strip 421 may be stably rotated into the spiral guide groove 511 without skewing, but the present disclosure is not limited to such arrangement, and the quantity of the arc convex strip 421 may also be one or three or more. The second combining part 51 is further provided with a stop block 512, the stop block 512 is located at an end of the spiral guide groove 511 and provided for stopping the arc convex strip 421. In some embodiments, the stop block 512 is located at an end of the spiral guide groove 511 farther away from the filter 30. In this way, when the bottle cap 50 is rotated to move each arc convex strip 421 along the spiral guide groove 511 to the position of the stop block 512, the arc convex strip 421 is stopped by the stop block 512, and the bottle cap 50 is unable to continue its rotation, so as to ensure that the locking position of the bottle cap 50 is consistent every time.

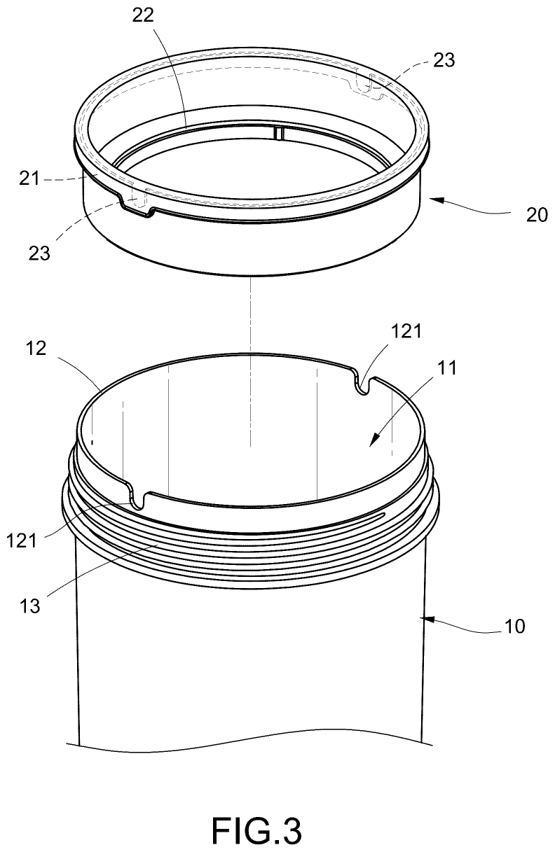

In FIG. 3, the bottle rim 12 of the bottle body 10 is provided with at least one positioning notch 121, the hollow rubber ring 20 is provided with at least one positioning bump 23 protruding from the hollow rubber ring 20. When the hollow rubber ring 20 sheathes the bottle rim 12, the positioning bump 23 is engaged with the corresponding positioning notch 121 to limit the hollow rubber ring 20 and prevent the hollow rubber ring 20 from rotating relative to the bottle body 10. In this embodiment, there are two positioning notches 121 and two positioning bumps 23 provided for effectively ensure that the hollow rubber ring 20 is unable to rotate relative to the bottle body 10, but the present disclosure is not limited to such arrangement.

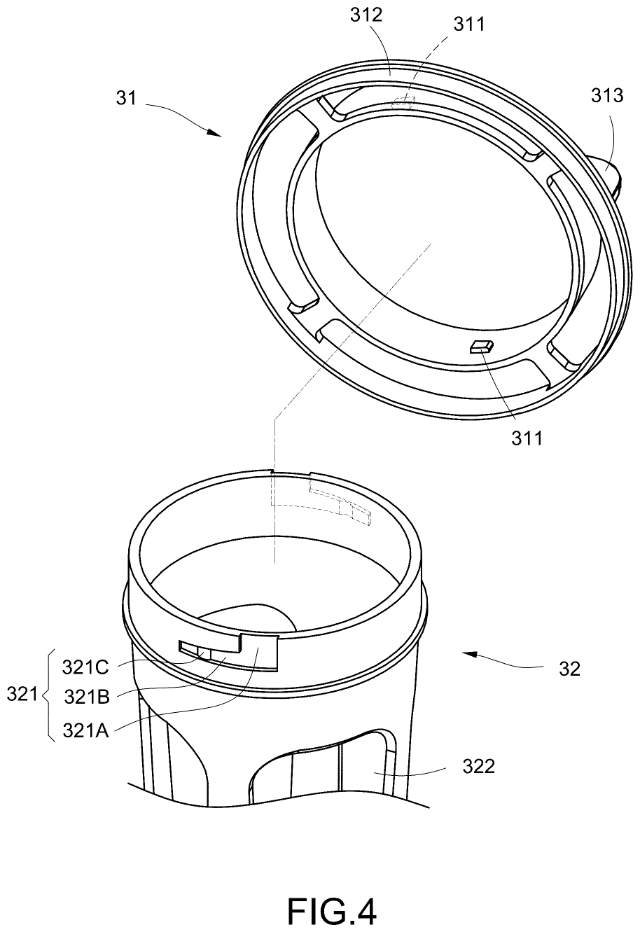

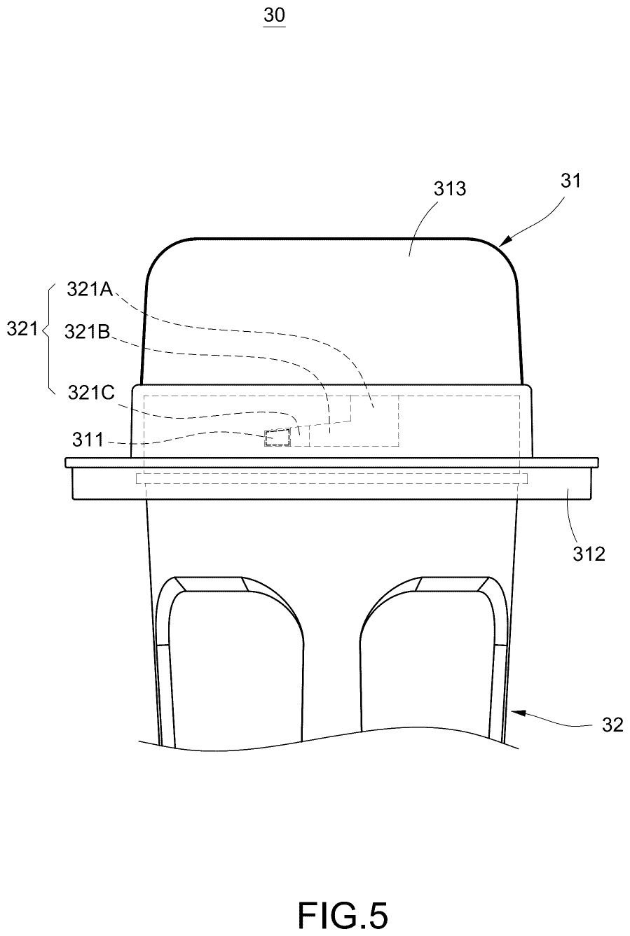

In FIGS. 4 and 5, the filter 30 includes a fixing cover 31 and a filter basket 32, the filter basket 32 is detachably installed to the fixing cover 31 and provided for users to change different types of filter baskets 32 according to the brewing requirements. The inner edge of the fixing cover 31 is provided with a plurality of snap blocks 311, the filter basket 32 is provided with a plurality of limiting element structures 321, each snap block 311 is engaged and positioned with each corresponding limiting element structure 321 to vertically limit the fixing cover 31, so as to fix the fixing cover 31 on the filter basket 32. In some embodiments, the limiting element structure 321 is in an inverted L-shape and includes a vertical groove 321A and a horizontal groove 321B perpendicular to each other, so that the snap block 311 may enter from the vertical groove 321A into the limiting element structure 321, and rotate to abut the horizontal groove 321B to achieve the positioning effect and provide simple assembling. In some embodiments, each horizontal groove 321B of the limiting element structure 321 is provided with a limiting bump 321C. When the fixing cover 31 is positioned, each snap block 311 engages with the closed position between each corresponding horizontal groove 321B and each corresponding limiting bump 321 to transversally limit the fixing cover 31 and prevent it from rotating. It is noteworthy that when it is necessary to remove the fixing cover 31 and the filter basket 32, each snap block 311 is rotated out of each limiting element structure 321 by applying a little force to release each snap block 311 from the restriction of each limiting bump 321C. In this way, the users are able to remove or place filter 30 directly into the cold brew bottle of the present disclosure after the bottle cap 50 is opened.

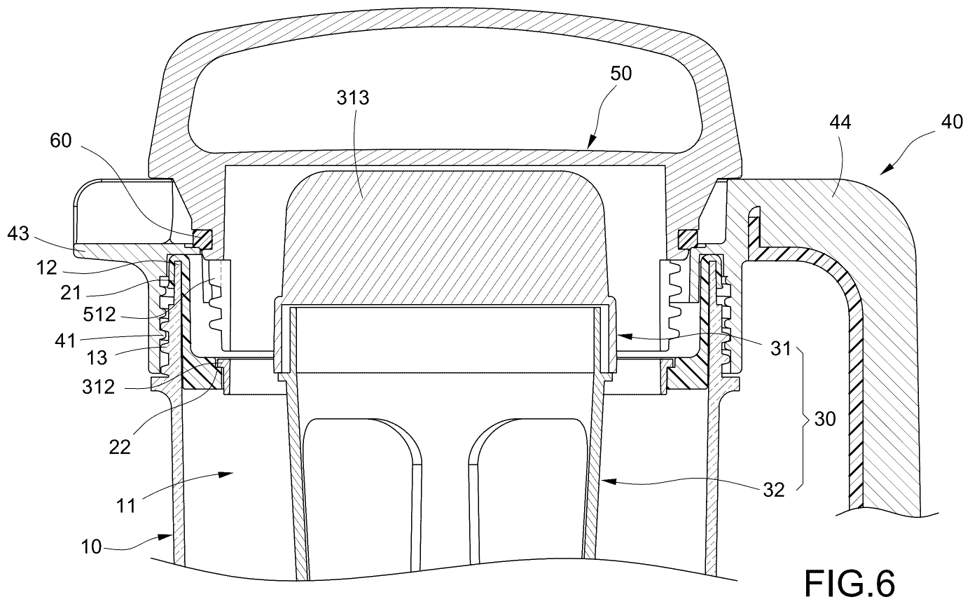

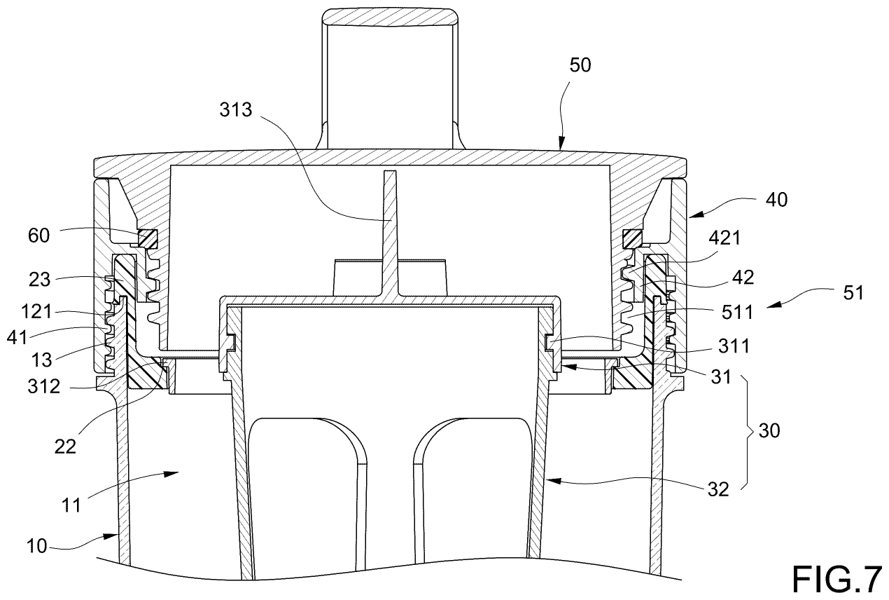

The filter basket 32 is substantially barrel-shaped and provided with a plurality of slots 322 for circulating liquid and at the same time blocking larger extractable substances such as fruit pulp or dried fruit, etc. In addition, a paper filter (not shown in the figures) or a metal filter (not shown in the figures) may be further placed in the filter basket 32 as required to filter finer extractable substances such as tea leaves or coffee powder. The fixing cover 31 is in a substantially circular shape, the outer edge of the fixing cover 31 is formed with a step difference 312, and the step difference 312 corresponds to the hanging of the hanging convex part 22 of the hollow rubber ring 20 as shown in FIGS. 6 and 7. In this way, the filter 30 is stably installed in the cavity 11 without skewing to ensure that the extractable substances in the filter basket 32 is uniformly extracted. The fixing cover 31 of the filter 30 perpendicularly extends towards a direction away from the filter basket 32 to form a gripping part 313, and the gripping part 313 of this embodiment is substantially in the shape of a rectangular sheet and provided for the users to grip, so as to facilitate the users to take out the filter 30 or remove the fixing cover 31 from the filter basket 32, but the present disclosure is not limited to such arrangements.

In FIGS. 1, 2, 6 and 7, the connection ring 40 includes a spout 43 and a handle 44 configured corresponding to each other. The spout 43 is substantially U-shaped and communicates to a hollow area of the connection ring 40, and further communicates with the cavity 11 of the bottle body 10. When the bottle cap 50 is detached from the corresponding connection ring 40, the spout 43 communicates with the cavity 11, so that the liquid in the cavity 11 of the bottle body 10 may be poured out from the spout 43. When the bottle cap 50 is combined with the corresponding connection ring 40, the spout 43 does not communicate with the cavity 11, so that the liquid in the cavity 11 of the bottle body 10 may not be poured out from the spout 43. The handle 44 is formed and extended from the connection ring 40 for facilitating the users to grip and carry the cold brew bottle. The cold brew bottle of the present disclosure further includes a rubber waterproof gasket 60 sheathing the second combining part 51 of the bottle cap 50, so that when the bottle cap 50 is combined with the connection ring 40, the rubber waterproof gasket 60 is clamped between the bottle cap 50 and the connection ring 40 to seal the gap between the bottle cap 50 and the connection ring 40, so as to achieve the waterproof sealing effect.

In summation of the description above, the present disclosure has novelty, non-obviousness and utility and complies with the patent application requirements, and thus is duly filed for patent application. While this disclosure has been described by means of specific embodiments, numerous modifications and variations may be made thereto by those skilled in the art without departing from the scope and spirit of this disclosure set forth in the claims.

What is claimed is:

1. A cold brew bottle, comprising:
a bottle body, comprising a cavity, an opening communicating with the cavity, and a bottle rim disposed at the opening;
a hollow rubber ring, adapted to sheathe the bottle rim, and comprising a hanging convex part extended from an inner edge thereof;
a filter, hung on the hanging convex part of the hollow rubber ring and contained in the cavity;
a connection ring, adapted to sheathe the hollow rubber ring and screwed with the bottle body; and
a bottle cap, detachably combined with the connection ring to close the cavity.

2. The cold brew bottle according to claim 1, wherein the hollow rubber ring comprises a sleeve part extended and bent outward from a top edge thereof, and the sleeve part is adapted to sheathe the bottle rim.

3. The cold brew bottle according to claim 1, wherein the bottle rim comprises at least one positioning notch defined thereon, the hollow rubber ring comprises at least one positioning bump disposed thereon, the positioning bump is engaged with the positioning notch to prevent the hollow rubber ring from rotating relative to the bottle body.

4. The cold brew bottle according to claim 1, wherein the filter comprises a fixing cover and a filter basket, the filter basket is detachably installed at the fixing cover, and the filter basket comprises a plurality of slots defined thereon.

5. The col d brew bottle according to claim 4, wherein the fixing cover is substantially in a circular shape, the hanging convex part is substantially in a ring shape, the fixing cover comprises a step difference disposed on an outer edge thereof, and the step difference is disposed corresponding to the hanging convex part.

6. The cold brew bottle according to claim 4, wherein the fixing cover comprises a plurality of snap blocks, the filter basket comprises a plurality of limiting element structures, each snap block is engaged and positioned with each limiting element structure to vertically limit the fixing cover.

7. The cold brew bottle according to claim 6, wherein each limiting element structure comprises a vertical groove and a horizontal groove perpendicular to each other, the horizontal groove comprises a limiting bump, and each snap block is engaged with the limiting bump to transversally limit the fixing cover.

8. The cold brew bottle according to claim 1, wherein the connection ring comprises a first combining part disposed inwardly, the bottle cap comprises a second combining part, and the second combining part is correspondingly combined with the first combining part.

9. The cold brew bottle according to claim 8, wherein the first combining part comprises at least one arc convex strip, the second combining part comprises a spiral guide groove, and the arc convex strip is rotatably engaged with the spiral guide groove.

10. The cold brew bottle according to claim 9, wherein the second combining part further comprises a stop block, and the stop block is located at an end of the spiral guide groove away from the filter for stopping the arc convex strip.

11. The cold brew bottle according to claim 8, further comprising a rubber waterproof gasket, adapted to sheathe the second combining part and clamped between the bottle cap and the connection ring.
